(19) United States
(12) Patent Application Publication
(10) Pub. No.: US 2010/0306125 A1
(43) Pub. Date: Dec. 2, 2010

(54) SYSTEM AND METHOD FOR DETERMINING THE MOST FAVORABLE LOCATIONS FOR ENHANCED GEOTHERMAL SYSTEM APPLICATIONS

(76) Inventors: Susan Petty, Shoreline, WA (US); Owen Callahan, Bellingham, WA (US); Matthew Clyne, Seattle, WA (US); Trenton Cladouhos, Seattle, WA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/791,735

(22) Filed: Jun. 1, 2010

Related U.S. Application Data
(60) Provisional application No. 61/182,271, filed on May 29, 2009.

(51) Int. Cl. G06Q 10/00

(52) U.S. Cl. 705/348

(57) ABSTRACT

A system and method for determining the most favorable locations for enhanced geothermal system applications are disclosed. According to one embodiment, a computer implemented method comprises receiving input data comprising characteristics of a subsurface geothermal resource and spatial parameters associated with extracting the subsurface geothermal resource, generating formulas and look-up tables based upon the input data, wherein the formulas and look-up tables relate a cost per rate to spatial attributes associated with the subsurface geothermal resource. Geographic information is combined with the formulas and look-up tables to create a map of the cost of each component of a plurality of components. A map is output of a total cost of electricity generation capability associated with the subsurface geothermal resource, wherein the total cost is calculated by summing the cost of each component of the plurality of components.

The present application claims the benefit of and priority to U.S. Provisional Patent Application No. 61/182,271 entitled “SYSTEM AND METHOD FOR DETERMINING THE MOST FAVORABLE LOCATIONS FOR ENHANCED GEOTHERMAL SYSTEM APPLICATIONS” filed on May 29, 2009, and is hereby incorporated by reference.

### FIELD

The field of the invention relates generally to computer systems. In particular, the present invention is directed to a system and method for determining the most favorable locations for enhanced geothermal system applications.

### BACKGROUND

The deeper down into the earth, the hotter it gets. Therefore, in theory, an Enhanced Geothermal System (EGS) can be constructed anywhere to extract heat from the earth and generate electricity. EGS shares this attribute with the other two major renewable energy sources, solar and wind.

Existing software tools do not provide for efficient and quick identification and comparison of potential enhanced geothermal project development sites. Note, ‘enhanced’ and ‘engineered’ can be used interchangeably when referring to geothermal project development sites.

Existing hydrothermal cost models are not exploratory tools; they do not allow for favorability or cost mapping across the landscape. Hydrothermal cost models are not designed for EGS. Spatial probability models typically used for natural resource mapping are not cost weighted, nor designed for EGS evaluation.

### SUMMARY

A system and method for determining the most favorable locations for enhanced geothermal system applications are disclosed. According to one embodiment, a computer implemented method comprises receiving input data comprising characteristics of a subsurface geothermal resource and spatial parameters associated with extracting the subsurface geothermal resource, generating formulas and look-up tables based upon the input data, wherein the formulas and look-up tables relate a cost per rate to spatial attributes associated with the subsurface geothermal resource. Geographic information is combined with the formulas and look-up tables to create a map of the cost of each component of a plurality of components. A map is output of a total cost of electricity generation capability associated with the subsurface geothermal resource, wherein the total cost is calculated by summing the cost of each component of the plurality of components.

The above and other preferred features, including various novel details of implementation and combination of elements, will now be more particularly described with reference to the accompanying drawings and pointed out in the claims. It will be understood that the particular methods and implementations described herein are shown by way of illustration only and not as limitations. As will be understood by those skilled in the art, the principles and features described herein may be employed in various and numerous embodiments without departing from the scope of the invention.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

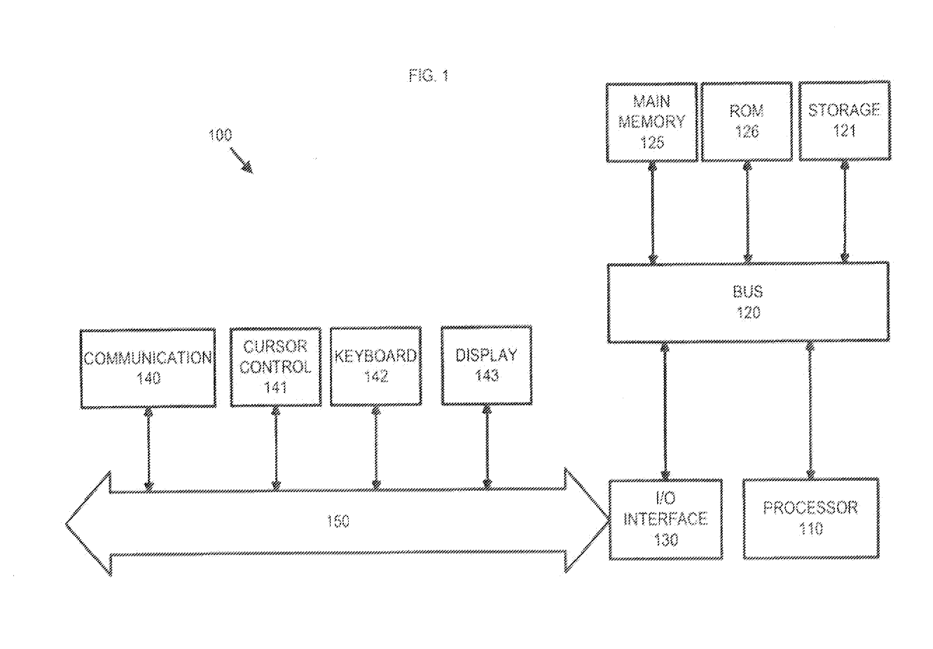

FIG. 1 illustrates an exemplary computer architecture for use with the present system, according to one embodiment.

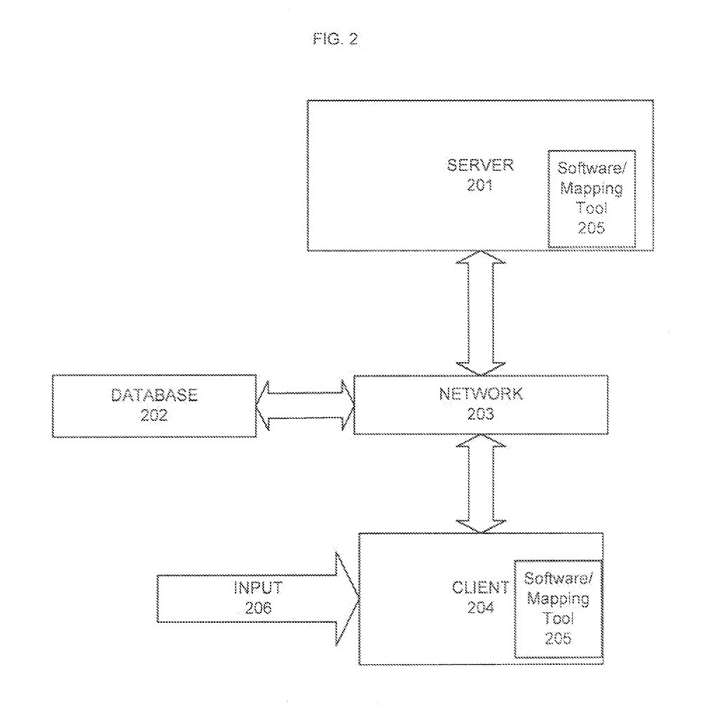

FIG. 2 illustrates an exemplary system level diagram for use with the present system, according to one embodiment.

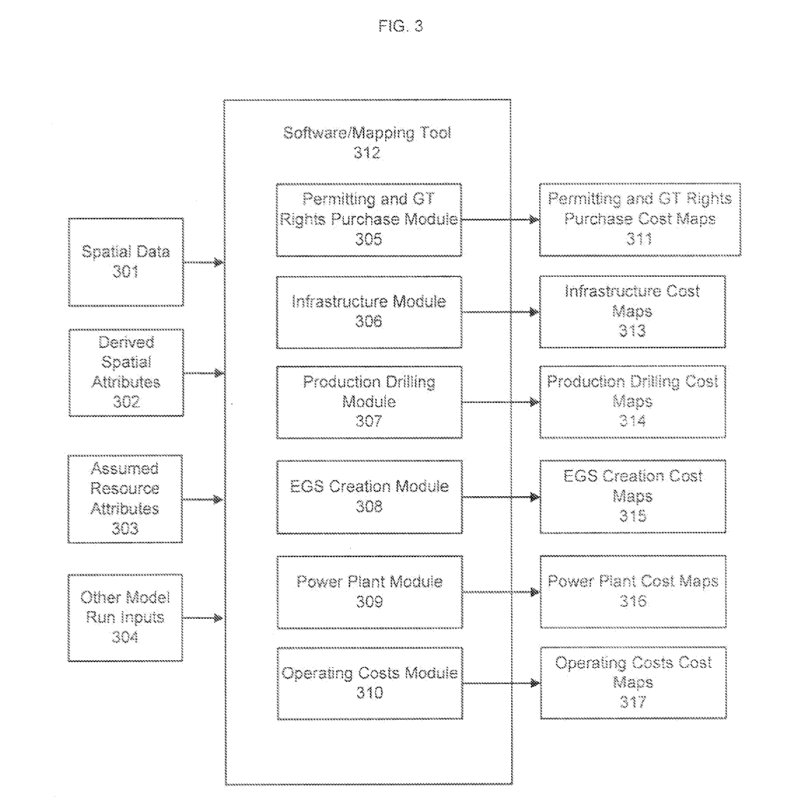

FIG. 3 illustrates an exemplary software module layout including inputs and outputs for use with the present system, according to one embodiment.

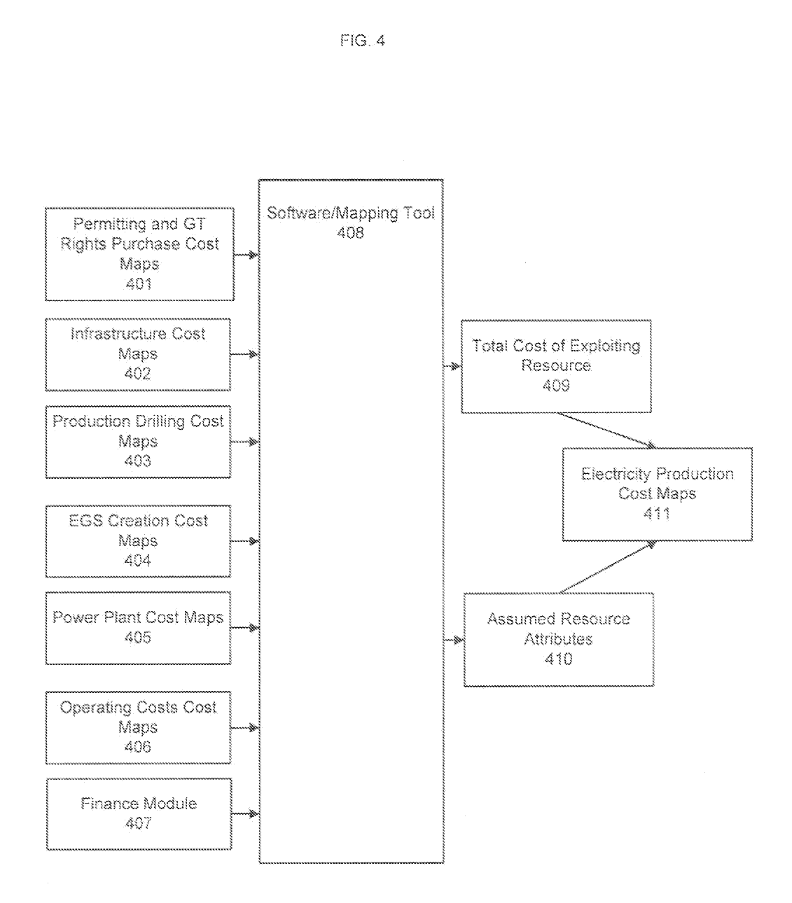

FIG. 4 illustrates an exemplary software module layout including final outputs for use with the present system, according to one embodiment.

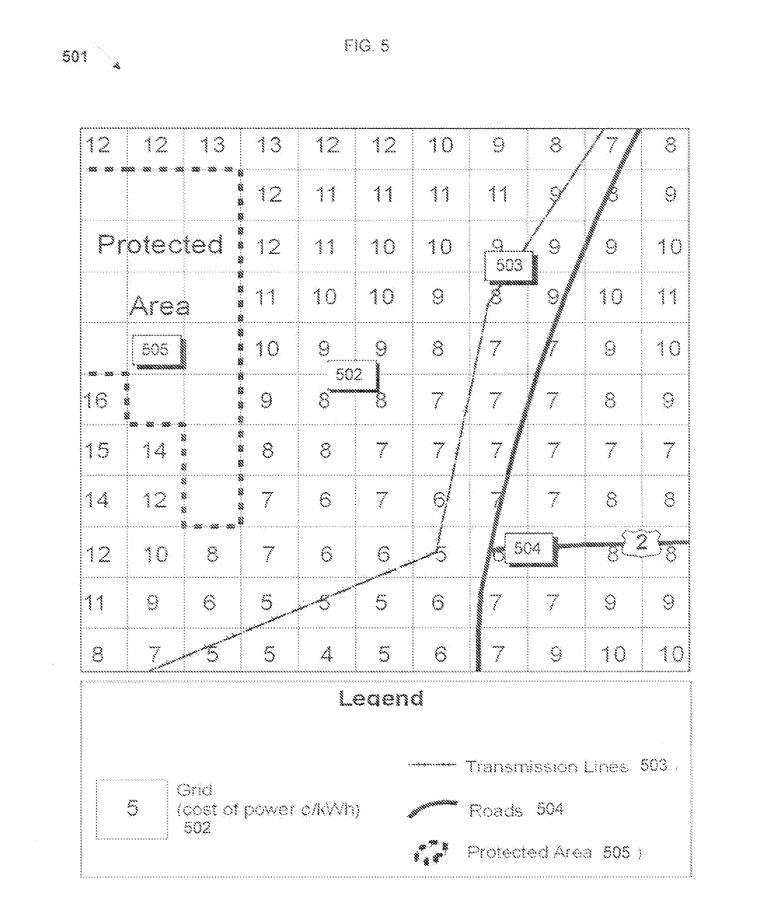

FIG. 5 illustrates an exemplary output map according to one embodiment of the present system.

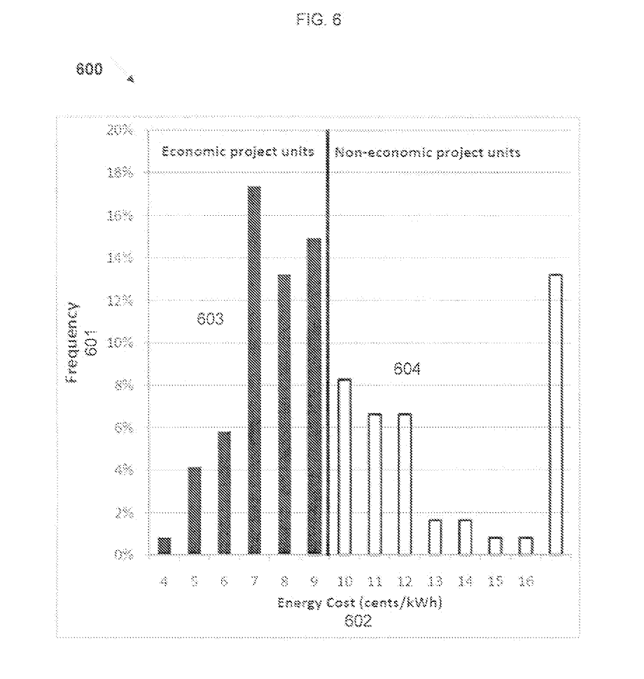

FIG. 6 illustrates an exemplary histogram output according to one embodiment of the present system.

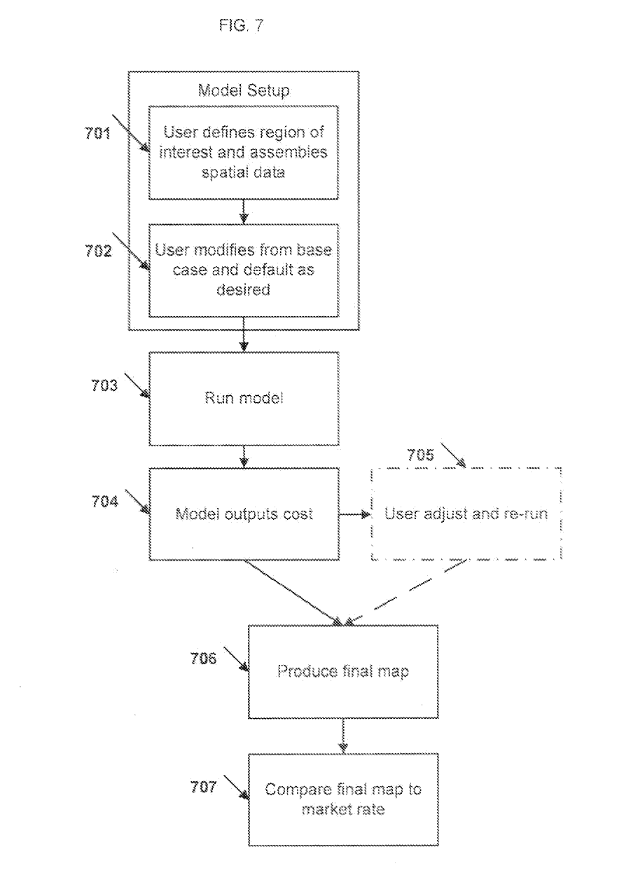

FIG. 7 illustrates an exemplary model process according to one embodiment of the present system.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A system and method for determining the most favorable locations for enhanced geothermal system applications are disclosed. According to one embodiment, a computer implemented method comprises receiving input data comprising characteristics of a subsurface geothermal resource and spatial parameters associated with extracting the subsurface geothermal resource, generating formulas and look-up tables based upon the input data, wherein the formulas and look-up tables relate a cost per rate to spatial attributes associated with the subsurface geothermal resource. Using map algebra, geographic information are combined with the formulas and look-up tables to create a map of the cost of each component of a plurality of components. A map is output of a total cost of electricity generation capability associated with the subsurface geothermal resource, wherein the total cost is calculated by summing the cost of each component of the plurality of components.

According to one embodiment, the present system determines the most favorable locations for Enhanced Geothermal System (EGS) applications by using multiple modules or layers.

Presently there are two general limits on where EGS can be deployed. First, there will be areas that must be excluded, such as national parks, wilderness areas, and urban areas. Second, areas will be identified that are uneconomic because the cost of generating power there exceeds the local electrical price (either current or predicted future price). The present system is a software mapping tool designed to sum the costs of bringing EGS electricity to the market. The cost can then be compared to the market rate to determine whether it would be economically feasible to implement EGS electricity generation at any given location. It will be appreciated that the present system is applicable to other energy sources, including but not limited to solar, wind, biomass, and combined cycles of two or more renewables (e.g. geothermal and solar-thermal).

According to one embodiment, the present system is a spatial cost evaluation tool. The present system does not rely on models of where geothermal resources should exist based on the statistical evaluation of geologic and geophysical data. Instead, the present system sets the resource as a known quantity and then estimates the cumulative cost to extract that known resource. An MIT study calculated that a subsurface reservoir volume of 1.5 cubic km of can produce 25 MWe for a projected lifetime of 20 years (Tester, J. W., Anderson, B., Batchelor, A., Blackwell, D., DiPippo, R., Drake, E., Garnish, J., Livesay, B., Moore, M. C., Nichols, K., Petty, S., Toksoz, N., Veatch, R., Augustine, C., Baria, R., Murphy, E., Negraru, P., Richards, M. 2006. “The future of geothermal energy: Impact of enhanced geothermal systems (EGS) on the United States in the 21st century.” Massachusetts Institute of Technology, DOE Contract DE-AC07-05ID14517 Final Report, 374 p.). Therefore, an exemplary base-case project unit for the present system can be defined as a) a 25 MWe resource, b) a project area of one square kilometer, c) a reservoir thickness of 5000 ft (1500 m), and d) a project lifespan of 20 years. With the resource defined, the present system estimates the cost to take this generic initial project through to electrical generation capability. Starting from the base case assumptions, alternative resource temperatures, volumes and lifespans can be assumed and modeled as well.

According to one embodiment, costs are discussed as occurring in a project unit of one square kilometer which, as a conceptual convenience, can also be considered as a pixel or grid cell on a regional map. In practice, pixel size depends upon the resolution of the data type and may be higher or lower. The terms, project unit and pixel, are used interchangeably in the following discussion.

According to one embodiment, the energy cost of EGS on any unit in the landscape can be defined by the cost to develop and maintain the site, divided by the extractable resource:

Simplified cost of energy=(Total Cost(¢))/(Resource(kWh))

Where the numerator can further be broken into the individual costs:

Total Cost=C+A+R+S+P+O+F
C=Project Initiation
A=Infrastructure
R=Production Drilling
S=Stimulation
P=power plant & transmission lines
O=Operations
F=Finance

And the denominator can be broken into the factors which define the resource:

Resource=(T×V)×Ep×L
T=temperature
V=volume of water
Ep=plant efficiency (%)
L=project lifetime.

To determine the total cost to extract the resource and deliver EGS electricity, the individual costs in the formula above are estimated in the current embodiment by several modules (FIGS. 3 & 4). Modules described in FIG. 3 calculate the subtotal cost to deliver a component or phase of a completed electricity-generating power station. Modules described in FIG. 4 calculate the cost to operate the plant for its planned lifetime. Each module is defined so a subject-matter expert provides and updates all relevant costs and formulas for that module. Care has been taken to ensure that the same costs are not calculated in more than one module and thus double-counted in the grand total.

According to one embodiment, the modules described FIGS. 3 & 4 roughly correspond to project phases and are arranged chronologically. There is, however, no requirement that any phase be complete before the next phase is initiated. Phases may not necessarily occur in series, they may occur with some overlap.

According to one embodiment, monetary cost is the primary focus of the present system. However, in order to properly evaluate the total monetary cost and investment return, the elapsed time of each phase and the cumulative time from initial investment to revenue are important factors. Therefore, the modules also output estimated time-to-complete the activities covered by the module. Practically, monetary cost and time spent are generally coupled, so in most of the modules estimating both monetary cost and time spent adds little extra effort. Throughout this document, the term “cost” can be interpreted to include one or both of monetary cost and time spent.

According to one embodiment, module outputs of cost are mean values. Optionally, modules can also be configured to output standard deviations on cost. This option allows for Monte-Carlo type sampling and best-case/worst-case analysis of the grand total costs.

According to one embodiment, each module outputs generic formulas or lookup tables that are employed to estimate specific costs required for each and every pixel or project unit within the region of interest based on the spatial attributes of each project unit. In one embodiment, the cost modules are programmed in proprietary VB Script within Microsoft's Excel. Cost modules may, however, be programmed in any platform provided that the outputs are readable by other components of the software system.

According to one embodiment, the present system receives as input spatial data that describes the region of interest. Table 2 lists the data types and examples of the specific input data. The spatial data is in the format of Geographic Information System (GIS) layers. GIS software is ideal for this kind of data processing because it allows data to easily be rasterized and georeferenced. Since the final product is a raster map of (nominal) square kilometer grid size, the use of GIS significantly reduces the complexity of performing the cost equations. Map algebra refers to combining costs or other data associated with pixel elements of multiple maps in an algebraic way (e.g. summing the costs of pixel elements in two maps). Map algebra is a built-in function of GIS software and allows for the computation of spatially dependent costs (transmission lines, transport of supplies, etc.). The cost equations can also be scripted into most GIS programs which allows automated computational processes, saving time and effort in rerunning the model.

After data collection, spatial data is loaded into a geodatabase and rasterized (FIG. 3, 301). A geodatabase is a special data container that allows spatial data (i.e. GIS layers) to be stored as a database (FIG. 3, 312). ArcGIS, a product of ESRI Corporation, stores tabular data in a relational database, allowing users to define keys to reference various data stored in other tables without having to repeat it. This allows data to be compact, modular, and well organized.

In preparation for a model run, the GIS data is further processed. First, exclusion zones are defined. Exclusion zones are those areas on the regional map such as national parks, wilderness areas, and urban areas, in which geothermal operations will never be allowed. In these areas of the map, no cost calculations are made. Second, spatial derivative variables for each pixel (slope, distance to substation, road, etc) are calculated (FIG. 3, 302). It may also be necessary to interpolate raster values across data gaps and adjust the resolution of various data sets. Before proceeding, the present system contains a series of conditionally independent data layers at the same resolution and with co-registered grids.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 2 illustrates an exemplary system level diagram for use with the present system, according to one embodiment. A server 201, having a software/mapping tool 205 according to the present system, is in communication with a network 203. A database is in communication with the network 203, and a client 204 is in communication with the network 203. The client 204 receives input 206 and also has a software/mapping tool 205 according to the present system.

FIG. 3 illustrates an exemplary software module layout including inputs and outputs for use with the present system, according to one embodiment.

A software mapping tool 312 includes several modules, including a permitting and GT (geothermal) rights purchase module 305, an infrastructure module 306, a production drilling module 307, an EGS creation module 308, a power plant module 309, and an operating costs module 310. As inputs, the software/mapping tool 312 receives spatial data 301, derived spatial attributes 302, assumed resource attributes 303, and other model run inputs 304. Outputs from the software/mapping tool include permitting and GT rights purchase costs maps 311, infrastructure cost maps 313, production drilling cost maps 314, EGS creation cost maps 315, power plant cost maps 316, and operating costs maps 317. Cost maps include the mean and standard deviation of cost (monetary and time spent) in dollars and cents. Further explanation of each module is as follows.

The permitting and GT rights purchase (or project initiation) module 305 incorporates the activities necessary to initiate a potential project of each pixel, including geothermal rights purchase, project unit characterization and permitting. While the present system sets the resource as the known quantity, the geological, geophysical and geothermal environment as well as cultural, political, biological, archeological, climactic, etc. setting of the project unit must be well-characterized in the first phase of the project. This information will be necessary to support the decision to purchase geothermal rights under the unit, for planning the rest of the project, and for environmental compliance and permitting. The project initiation subtotal cost and schedule depends primarily on the project unit's owner (federal, state, county or private), previous studies performed, the existing level of development, and secondarily on many other factors.

The infrastructure module 306 estimates the costs of building roads to each project unit or pixel in order to provide access to drill rigs and construction vehicles. In remote areas, costs may also need to be added to construct and maintain a labor camp. While construction of transmission lines can be included here, in this embodiment, it is included in the power plant construction. The infrastructure subtotal cost depends on spatial attributes such as each pixel's proximity to existing roads, the topography and land ownership along the path to the existing infrastructure, as well as non-spatial costs such as road building materials.

The simplest EGS consists of three wells, an injector at the middle of the reservoir and two producers at the reservoir edges. The production drilling module 307 estimates the cost of this base case scenario to drill three wells. The subtotal cost of production drilling depends primarily on the depth to the target temperature, and depth to the bedrock. These are spatial attributes that influence the amount of drilling time required. This subtotal also depends upon the transportation and material costs of the steel casing used to line the well bore.

The reservoir of an EGS is created by injecting cold water into one or more of the wells to create a network of flowing fractures (also known as stimulation or hydroshearing) which connect the wells. The EGS creation module 308 estimates the cost to obtain the injection water and pump it into the injector at sufficient pressure to cause hydroshearing. The subtotal cost of EGS reservoir creation depends primarily upon the local water availability, distance to closest service center, and the minimum principle stress (which in turn depends upon the depth to the target temperature and tectonic setting).

The power plant module 309 estimates the costs of constructing the surface components of a geothermal power plant as well as the transmission line and power substation to deliver electricity to the grid. Other embodiments split the transmission line and power substation into a separate module. Average power plant efficiency and design will depend upon the average air temperature of the project unit and the availability of cooling water. For the base-case a 10% heat to electric-power efficiency, typical of binary plants is assumed. For regions in which plant efficiency is predicted to vary greatly within the region of interest, this module can be configured to output the plant efficiency by pixel which can then be used to alter the resource on a pixel-by-pixel basis as well.

The power plant construction subtotal cost and optional plant efficiency adjustment for each pixel depends on spatial attributes of the pixel such as climate, as well as the topography and land ownership along the path project unit to the existing transmission lines and power substations. This subtotal cost also depends greatly on non-spatially dependent costs such as plant equipment (turbines, generators, and transformers), building materials, and labor rates.

The operating costs module 310 estimates the cost of operating and maintaining a geothermal power plant on each project unit. According to one embodiment, for the base case scenario and for financial planning, a lifetime of 20 years is used. Operating costs also include royalties and taxes paid. The operating costs subtotal cost depends upon the project unit's spatial attributes of average air temperature, the availability of cooling water, and landownership.

FIG. 4 illustrates an exemplary software module layout including final outputs for use with the present system, according to one embodiment. A software/mapping tool 408 receives as inputs permitting and GT rights purchase cost maps 401, infrastructure cost maps 402, production drilling cost maps 403, EGS creation cost maps 404, power plant cost maps 405, operating costs cost maps 406, and output from a finance module 407. The outputs from the software/mapping tool 408 include a total cost of exploiting the resource 409, assumed resource attributes 410, and those are combined to produce electricity production cost maps 411. The electricity production cost maps 411 include a best case, mean, and worst case cost.

The finance module 407 operates on costs generated by the other modules rather than on any spatial attributes. The finance module 407 estimates the costs of financing the project. This module is also responsible for formulas used to sum the individual costs from the other six modules. In the simplest mode, this module operates in today's dollars and directly sums the individual costs. For the purposes of geographic comparisons, this mode may be sufficient. In more complex embodiments, the cumulative time and cost of each phase can be used to inflate costs, calculate interest owed, and determine net present value (NPV) and return on investment (ROI).

FIG. 5 illustrates an exemplary output map according to one embodiment of the present system. An exemplary output map 501 includes transmission lines 503, roads 504, protected areas 505, and a grid indicating the total cost of power 502. The grid can be contoured and color coded to show a gradient according to differences in cost 502 (represented by numbers in the grid on FIG. 5).

FIG. 6 illustrates an exemplary histogram output according to one embodiment of the present system. An exemplary histogram 600 includes a view of frequency 501 versus energy cost 602. The histogram 600 also includes economic project units 603 and non-economic project units 604.

FIG. 7 illustrates an exemplary model process according to one embodiment of the present system. Model setup includes a user defining regions of interest and assembling the necessary spatial data associated with the regions 701. Spatial data may be public or private domain material. The user may then modify from the base case and default 702. The user may choose to alter the project unit size, resource volume, electricity output, lifespan, or project start year from the base case. The user may also modify the default settings of each module as part of sensitivity analysis. Changes in any module's inputs forces lookup tables and formulas within a GIS project to be updated. This is accomplished by exporting comma delimited text files from the module and importing the tables into ArcGIS.

The user then runs the model 703 based upon the setup choices made. The present system produces a series of intermediate spatial cost maps 704. For any of the individual phases (modules), the user can display mean cost and mean time-to-complete, as well as standard deviations or standard percentile values. The user can adjust the initial conditions and inputs and re-run the model 705. When satisfied with the intermediate costs, the user chooses financial options for summing the costs into the grand total cost sum. For example, the sum may be a simple addition of mean values, or based on a Monte Carlo sampling of a statistically significant population of realizations. Another user option is whether to operate in today's dollars or use the elapsed time to account for the time-value of money.

A final map is produced 706. In the final “simplified cost of energy” map, the grand total cost is divided by the resource, adjusting for plant efficiency, if necessary. If the option is chosen, in addition to the mean costs, best-case (i.e. 5th percentile) and worst case (i.e. 95th percentile) maps are generated as well.

The final maps are compared to the market rates 707 for electricity in the project area's region, and a threshold is set to screen for only areas suitable for EGS development.

Table 1 highlights outputs of exemplary modules herein.

TABLE 1
Exemplary cost module outputs, according to one embodiment.

| Module | Examples of Multivariate Lookup Tables Output by Module |
|---|---|
| Project Initiation | Cost of geothermal rights as a function of landownership, county |
| (Permitting and GT | and state |
| Rights Purchase) | Permitting costs and elapsed time required as a function of |
| | landownership, distance to sensitive areas, and water bodies. |
| Infrastructure | Road Construction Costs (dollars/mile and miles/day) as a |
| | function of physical and legal accessibility, land ownership, and |
| | distance to construction support facilities. |
| Production Drilling | Total drilling costs (dollars/foot and feet/day) as a function of |
| | total depth, depth to bedrock and distance to service centers |
| Stimulation | Pumping costs as a function of minimum principle stress, and |
| | reservoir depth and distance to service centers |
| Development/ | Transmission line construction cost rate (dollars/mile and |
| Construction | miles/day) based on a function of physical and legal accessibility |
| | and distance from construction support facilities. |
| | Power plant construction cost as a function of resource size and |
| | predicted plant efficiency. |
| Operating Costs | Power plant efficiency as a function of climate (includes air |
| | temperature and humidity). |
| | Water costs as a function of availability and fees. |
| | Royalties and taxes as function of landownership, state, and |
| | county |
| Finance | Finance and other costs as a function of the year in which |
| | invested funded are spent and time to revenue. |

Table 2 highlights exemplary input for the present system, according to one embodiment.

TABLE 2
Exemplary inputs, according to one embodiment.

| | Example Inputs |
|---|---|
| Spatial Data (Layers) | |
| Points | Substation locations, well locations, hot |
| | spring locations, etc. |
| Vectors | Roads, rivers, transmission lines, faults, etc. |
| Polygons | Boundaries of states, counties, landownership |
| | (federal, state, private), zoning, exclusion |
| | zones (wilderness areas, national parks, urban |
| | areas), etc. |
| Contours of Surface | Depth to target temperature, elevation, water |
| | table, depth to bedrock, climate (precipitation, |
| | air temperature) |
| Raster Data | DEM (digital elevation model), etc. |
| Cost Data | |
| Non-spatial | Material costs per unit, drilling rig daily rate, |
| dependent | construction costs per unit, finance costs, etc. |
| Spatially dependent | Rig mobilization, transport costs, cost per mile |
| | for road or transmission line, cumulative drilling |
| | cost (depth), cumulative stimulation cost, etc. |

A system and method for determining the most favorable locations for enhanced geothermal system applications have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

We claim:

1. A computer-implemented method, comprising:
receiving input data comprising characteristics of a subsurface geothermal resource and parameters associated with extracting that the subsurface geothermal resource;
generating formulas and look-up tables based upon the input data, wherein the formulas and look-up tables relate a cost per rate to spatial attributes associated with the subsurface geothermal resource;
combining geographic information with the formulas and look-up tables to create a map of the cost of each component of a plurality of components; and
outputting a map of a total cost of electricity generation capability associated with the subsurface geothermal resource, wherein the total cost is calculated by summing the cost of each component of the plurality of components.

2. The computer-implemented method of claim 1, wherein input data includes data associated with land ownership, precipitation, air temperature, topography, roads, transmission lines, mapped faults and fractures, stress magnitudes, depth to the subsurface geothermal resource, depth to bedrock, habitat of endangered species, cultural resources, recreation areas, watershed, and scenic areas.

3. The computer-implemented method of claim 1, wherein the formulas and look-up tables comprise relationships associated with project initiation, infrastructure, production drilling, EGS generation, power plants, operating costs, and finance.

4. The computer-implemented method of claim 1, further comprising comparing the map of total cost to market rates and determining that an area is economical for EGS.

5. The computer-implemented method of claim 1, further comprising calculating cost uncertainties per component.

6. The computer-implemented method of claim 1, wherein components include project initiation, infrastructure, production drilling, EGS generation, power plants, operating costs, and finance.

7. The computer-implemented method of claim 1, wherein the formulas and look-up tables are generated using at least one of Excel, VBScript, and ArcMap.

8. The computer-implemented method of claim 1, wherein a user configures input assumptions and data sets.

9. A system, comprising:
a server in communication with a network, wherein the server is in communication with a database over the network; and
a client device in communication with the network, the client device having instructions stored thereon, the instructions, when executed by the client device, causing the client device to:
receive input data comprising characteristics of a subsurface geothermal resource and parameters associated with extracting the subsurface geothermal resource;
generate formulas and look-up tables based upon the input data, wherein the formulas and look-up tables relate a cost per rate to spatial attributes associated with the subsurface geothermal resource;
combine geographic information with the formulas and look-up tables to create a map of the cost of each component of a plurality of components; and
output a map of a total cost of electricity generation capability associated with the subsurface geothermal resource, wherein the total cost is calculated by summing the cost of each component of the plurality of components.

10. The system of claim 9, wherein input data includes data associated with land ownership, precipitation, air temperature, topography, roads, transmission lines, mapped faults and fractures, stress magnitudes, depth to the subsurface geothermal resource, depth to bedrock, habitat of endangered species, cultural resources, recreation areas, watershed, and scenic areas.

11. The system of claim 9, wherein the formulas and look-up tables comprise relationships associated with project initiation, infrastructure, production drilling, EGS generation, power plants, operating costs, and finance.

12. The system of claim 9, further comprising comparing the map of total cost to market rates and determining that an area is economical for EGS.

13. The system of claim 9, further comprising calculating cost uncertainties per component.

14. The system of claim 9, wherein components include project initiation, infrastructure, production drilling, EGS generation, power plants, operating costs, and finance.

15. The system of claim 9, wherein the formulas and look-up tables are generated using at least one of Excel, VBScript, and ArcMap.

16. The system of claim 9, wherein a user configures input assumptions and data sets.
